(19) United States
(12) Patent Application Publication
(10) Pub. No.: US 2024/0350240 A1
(43) Pub. Date: Oct. 24, 2024

(54) DENTAL BRIDGE AND METHODS FOR ITS MANUFACTURE AND INSTALATION

(71) Applicant: Iveneer LTD, Petach Tikva (IL)

(72) Inventor: Itay MISHAELOFF, Petach Tikva (IL)

(21) Appl. No.: 18/685,524

(22) PCT Filed: Sep. 4, 2022
(86) PCT No.: PCT/IL2022/050961

§ 371 Date: Feb. 22, 2024

(30) Foreign Application Priority Data
Sep. 5, 2021 (US) 63/240949

(51) Int. Cl. A61C 13/087; A61C 13/271

(52) U.S. Cl. CPC A61C 13/087; A61C 13/26; A61C 2201/00

(57) ABSTRACT

A matrix for making a dental bridge includes a body of a tooth portion and wings, and an interior of the body for receiving a curable flowable material.

### CROSS-REFERENCES TO RELATED APPLICATIONS

This application is related to and claims priority from commonly owned U.S. Provisional Patent Application Ser. No. 63/240,949, entitled: Dental Bridge And Methods For Its Manufacture And Installation, filed on Sep. 5, 2021, the disclosure of which is incorporated by reference in its entirety herein.

### TECHNICAL FIELD

The present disclosure is directed to prosthetic dentistry, and in particular to dental bridges.

### BACKGROUND

Dental bridges typically require a porcelain tooth. As a result, a patient must be measured for the tooth, by impressions and the like, the tooth must be ordered from a laboratory, with the basic bridge, with the tooth made in the laboratory. These manufacturing processes take time, at least a period of days, before the bridge is installed in the mouth. Should the porcelain tooth not fit the tooth space, the process must be repeated, resulting in additional time. While some bridges may be made in the dentist's office, the manufacture and installation requires substantial time, typically taking hours, with multiple similar length appointments necessary sometimes.

### SUMMARY

The present disclosure provides methods and systems for making dental bridges, such as Maryland bridges. These Maryland bridges include a prosthetic tooth with oppositely disposed wings, which attach to the lingual sides of adjacent teeth. The prosthetic tooth fills the space between the existing adjacent teeth, and replaces a previous tooth, a removed tooth, or a missing tooth.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIGS. 1A and 1B are front and rear perspective views of a matrix for use in creating a dental bridge in accordance with disclosed embodiments;

FIG. 2 is a cross-sectional view of the matrix taken along line 2-2 of FIG. 1A;

FIG. 3A-1 is a side sectional view of the matrix taken along line 3A-3A of FIG. 1A;

FIG. 3A-2 is a cross-sectional view of the matrix taken along line 2-2 of FIG. 1A used to illustrate the separable portions of the matrix;

FIG. 3B is a cross-sectional view along line 3B-3B of FIG. 3A-1;

FIG. 4 is a sectional view of the matrix showing a fiber splint placed into the matric for reinforcing the bridge made in the matrix;

FIG. 5 shows an example matrix in an example process being filled with composite material, as viewed from the buccal side of the lower denticia (teeth);

FIG. 6 shows the material in the example matrix being cured in accordance with the example process, as viewed from the buccal side of the lower denticia (teeth);

FIG. 7 shows a Maryland bridge produced by the example process in accordance with a disclosed embodiment as viewed from the lingual side of the lower denticia (teeth); and,

FIG. 8 shows a finished reinforced bridge in accordance with an embodiment as viewed from the lingual side of the lower denticia (teeth).

### DETAILED DESCRIPTION OF THE DRAWINGS

Throughout this document, references to directions and orientations, such as inward, outward, inner, outer, upper, lower, lateral and the like. The references to these directions and orientations are exemplary, for describing and explaining the present invention, and embodiments thereof, and are not limiting in any way.

The present disclosure provides methods and systems for making dental bridges, such as Maryland bridges. These Maryland bridges include a prosthetic tooth with oppositely disposed wings, which attach to the lingual sides of adjacent teeth. The prosthetic tooth fills the space between the existing adjacent teeth, and replaces a previous tooth, a removed tooth, or a missing tooth. The Maryland bridge is formed by from a matrix, corresponding to the shape of the replaced tooth, with side (laterally disposed) wings for attaching to the respective adjacent tooth, for anchoring the replaced tooth. The matrix is positioned in the spot of the tooth to be replaced, filled with a curable material, and the material is cured to harden. Upon hardening, the matrix is removed, for example, cut away, and the prosthetic tooth is now in the space of the previous tooth it replaces, with wings in contact and adhered to the adjacent teeth, to support the prosthetic (replacement) tooth. The wings may be reinforced by rods, fibers, splints, and the like, placed into the matrix and spanning the wings, prior to curing, which become integral with the Maryland bridge upon curing. As all of the materials, i.e., the matrix, the curable material, and optional reinforcements, are available to the dentist or other health professional, and the curing, e.g., using ultraviolet (UV) light, as the curable material cures in the presence of UV light) typically takes seconds and not more than a minute minutes, the entire process is performed in a short time, for example, about one hour, and only requires a single office visit.

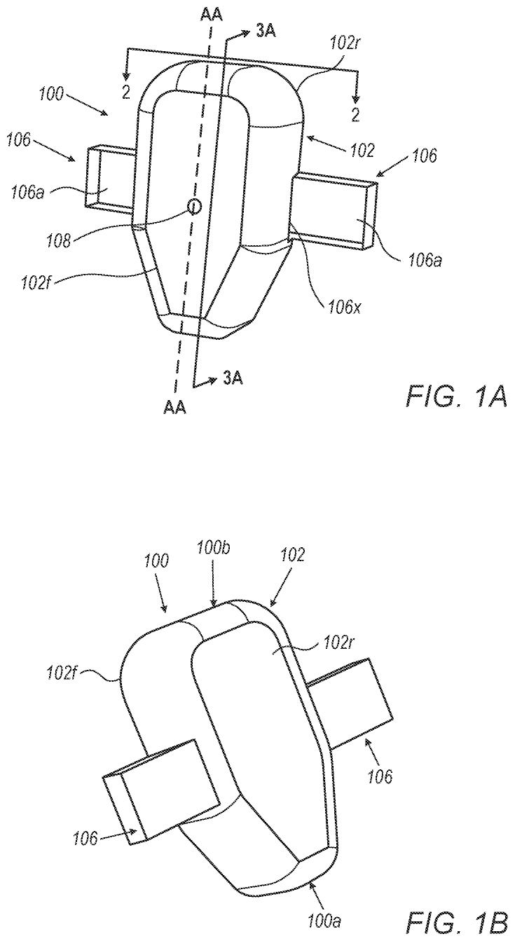

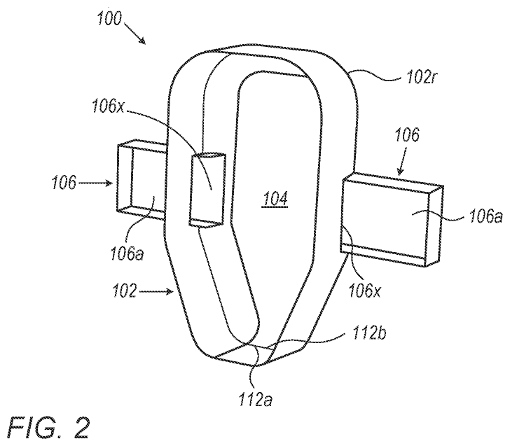

FIGS. 1A and 1B show a matrix 100 in accordance with an embodiment of the disclosed subject matter. The matrix 100 includes a body 102, with facial or buccal 102f and palatal or lingual 102r sides. The body 102 is shaped and dimensioned to the shape of a tooth. The body 102 includes a hollow interior or cavity 104 (FIG. 2). Laterally disposed arms 106, include cavities 106a, which, for example, are open on the facial or buccal side 102f, and closed on the palatal or lingual side 102r. The hollow interior or cavity 104 and the cavities 106a form an interior cavity of the matrix 100. The body 102 includes lateral openings 106x, such that the interior 104 opens into the respective cavities 106a, of the laterally disposed arms 106. The openings 106x, arms 106, and cavities 106a, shown as rectangular, one or more, may also be square, rounded, triangular, combinations thereof, or any other shape, for example, depending on the wings 222 of the bridge 200 to be formed. For example, the laterally disposed arms 106 support the formation of wings 222 (FIG. 8) extending from the tooth (e.g., replaced or prosthetic tooth 220 of FIG. 8), the wings which attach, adhere or otherwise bond to the adjacent teeth 204 (FIG. 8), as part of the formed bridge. The matrix 100, is, for example, symmetrical about the axis AA-AA.

At least one aperture 108 is located on the body 102, for example, on the facial or buccal side 102f, but may also be on the lingual or palatal side 102r or the lateral sides. The aperture 108 is dimensioned to accommodate a syringe 210 (FIG. 4) to deliver material to the matrix through the aperture 108. The aperture 108 is circular in shape, but other shapes, such as square, rectangular, rounded, oval, triangular, combinations thereof, and the like, are also suitable, provided they accommodate a syringe, needle or other injection structure. While a single aperture 108 is shown, multiple apertures at multiple positions and/or multiple sides of the body 102, are also permissible.

The matrix 100 is shown in an example orientation, with a side 100a for contacting the gum and an incisal side 100b for facing the opening of the mouth (FIG. 1B), in the orientation, for example, where a bridge is formed for a lower incisor. As such, the matrix 100 is used for forming a bridge, such as a Maryland bridge, in the lower denticia (lower teeth), but is easily reoriented for a Maryland bridge in the upper denticia (upper teeth). The pontic design of the matrix 100, for example, may be saddle shaped (e.g., ridge laps, ovate, or modified), to correspond to the shape of the gum surface.

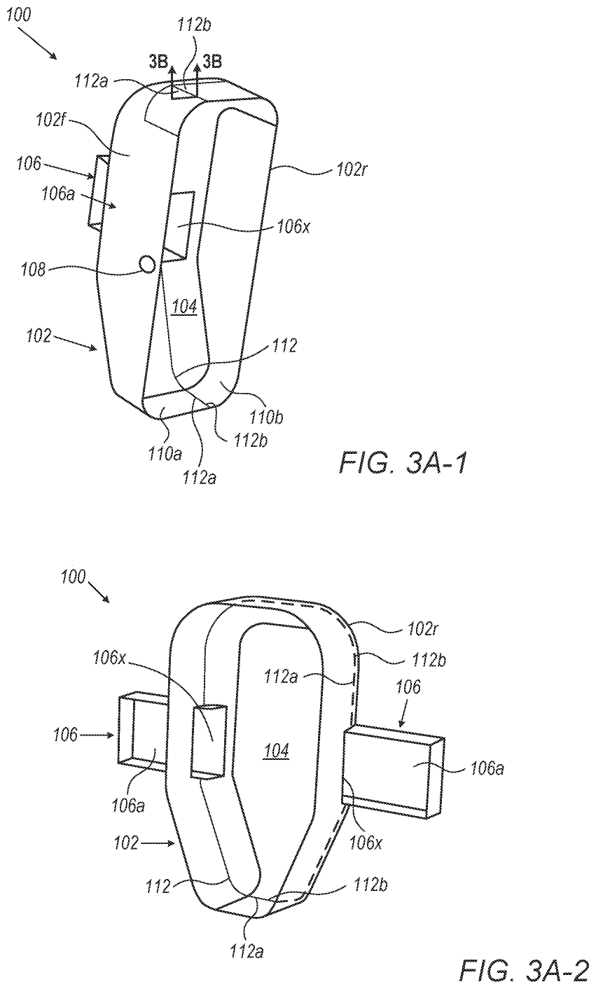

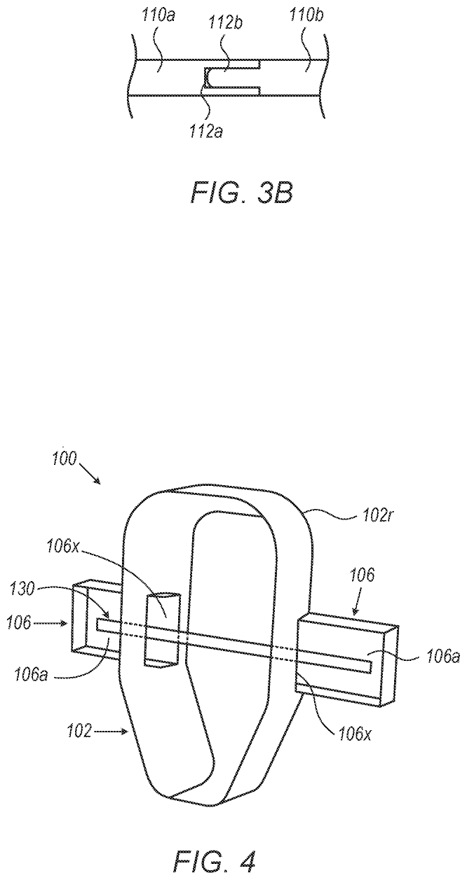

As shown in FIGS. 2, 3A-1, and 3A-2, the matrix 100, i.e., the body 102 is formed, for example, of two sections 110a, 110b, separable, e.g., removably attachable, from each other, for example, about the line 112. In FIG. 3B, the edges 112a, 112b of the sections 110a, 110b, for example, are correspondingly configured, e.g., a male (112b)-female (112a) fit, to engage each other with a joining force, which is, for example, by frictional forces, that are sufficient to keep the sections joined during injection, e.g., filling of material into the interior 104 and cavities 106 (through the lateral openings 106x), and curing, while allowing the sections 110a, 110b to be manually separated from each other and removed from the mouth, once the material has cured and bridge is complete. The sections 110a, 110b are shown as asymmetric with respect to the body 102 in FIGS. 2, 3A-1 and 3A-2, but sections 110a, 110b of the body 102 may be symmetric.

Alternately, the matrix 100, e.g., the body 102, does not have to be in separable sections 110a, 110b, but may be a unitary member, with or without the arms 106. In this case, once the bridge 200 is made and cured, the matrix may be cut and removed from the bridge 200.

The body 102 is typically formed in sections 110a, 110b, with one section 110b, for example, formed integral with the arms 106. The matrix 100 is such that the body 102 is, for example, dimensioned to form the tooth 220 of the bridge 200, and the arms 106 are dimensioned to form the wings 222 of the bridge 200, as shown in FIG. 6. The sections 110a, 110b including the arms 106, are, for example, made of a light transmissive material, such as a translucent or transparent material, to allow the passage of light through to the matrix 100, the light, such as ultraviolet (UV) light, for curing the flowable composite material, which was previously injected into the matrix 100, as detailed below. The translucent or transparent material includes thermoplastic materials, such as medical grade acrylic, polypropylene, polyethylene, ABS, nylon, siliconized rubber, which are biocompatible, inert and non-toxic. The thermoplastic materials are such that the body 102 and in particular, the arms 106, are flexible to bend, such that they can be pressed against the adjacent teeth to correspond to the shape (e.g., the curvature or pathway) of the adjacent teeth, along the lingual/palatal surfaces.

The materials of the matrix 100 (e.g., body 102 and arms 106) are, for example, of an approximately uniform thickness, of approximately 0.025 mm to 0.5 mm. The matrix 100 is typically disposable (e.g., single use), but may also be for multiple uses.

The injected material, for example, is a flowable and restorative material, such as a UV light curable composite (material), or other hardenable (e.g., dental grade) material (which when cured, for example, hardens to a hardness of a natural tooth or harder). Example materials include UV light curable composites, such as ESPE 6020A3 Filtek® Z250 Universal Restorative Refill, from 3M, St. Paul, Minn., and Herculite® Ultra Flow Nanohybrid Flowable Composite from Kerr. The UV light curable material is injected, by a syringe 210 through the aperture 108 in body 102, into the interior 104, as shown, for example, in FIG. 4, and flows through the openings 106x into the cavities 106a of the arms 106. The syringe 210, for example, may be a 1-4 gram syringe.

The injection by the syringe 210 is under pressure (of the syringe plunger), and fills the interior 104 and arms 106 (arm cavities 106a), in a manner which eliminates air bubbles and air gaps in the injected composite material. As a result of all air bubbles and air gaps being eliminated, oxygen cannot reach the dental composite and a nonoxygen inhibited layer is formed in the interior 104 and arms 106, whose open area is sealed against the adjacent teeth, allowing for the composite to be well cured, as detailed below, as well as avoiding contamination of the composite material from blood, saliva, body fluids, other contaminants and the like. The injection is complete, for example, when composite material exits the matrix 100 through the aperture 108.

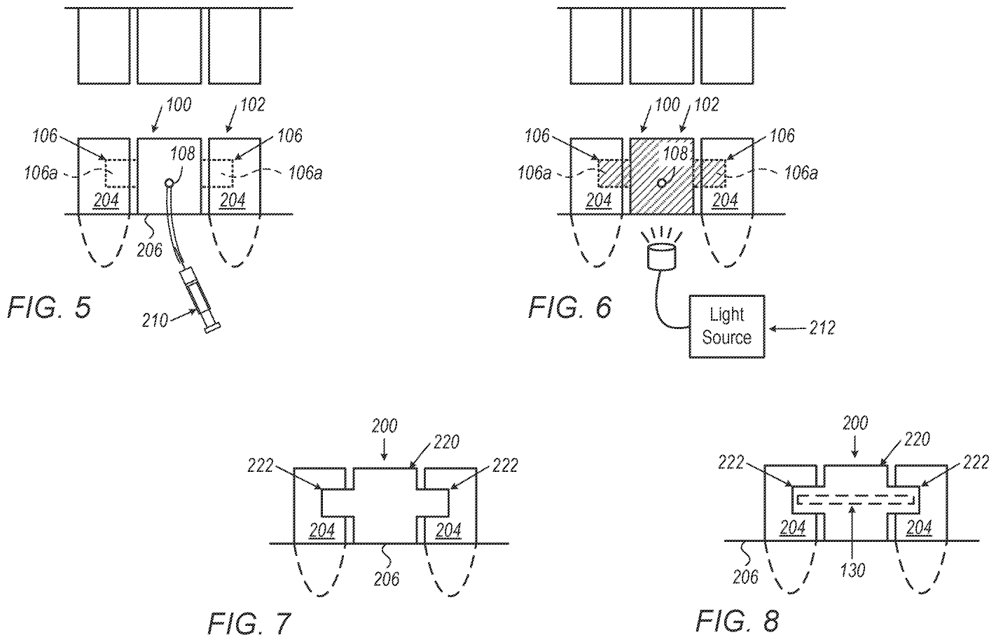

The matrix 100, for example, is formed, for example, of engaging and removably attachable unitary members 110a, 110b, and is shaped for a particular tooth (and the curvature formed by the adjacent teeth and the palatial surface), such as a lower incisor, for example, as shown in FIGS. 5-7. However, all teeth of the denticia may be produced as part of a Maryland bridge in the manner disclosed herein.

FIG. 4 shows a matrix 100 where the bridge 200 is reinforced by a rod 130, fiber, splint, or other reinforcing structure. The rod 130 is typically inserted into the matrix, so as to span from each of the arms 106. The flowable material is inserted into the cavity 104 and arms, such that the rod 130 typically strengthens the bridge 200 (FIGS. 7 and 8) which has been formed. The rod 130, for example, may be made of surgical grade metals, fibers, and the like, but should be flexible to bend with the body 102 and arms 106, when necessary. While one rod 130 is shown, multiple rods, fibers, splints, or other reinforcing structures are also permissible.

An example process using the matrix 100 to make a Maryland bridge 200 on the lower teeth 202, e.g., lower incisor, is shown, for example, in FIGS. 5, 6 and 7. Initially, and optionally, the adjacent teeth 204, adjacent to the space 206 to be replaced by the matrix 100 and ultimately the prosthetic tooth 220, are prepared by the clinician.

The resultant prosthetic tooth 220 (made by the matrix 100) will seat in the space 206 of the tooth it is replacing, next to adjacent teeth 204 on each (lateral) side, in the denticia, as shown, for example, in FIGS. 5-8, and detailed below. As shown in FIG. 5, a view from the buccal side of the teeth 204, the matrix 100 is positioned, so that the body with 102 seats in the space 206, between two adjacent (and existing) teeth 204, and the open buccal sides 102f of the cavities 106a (on the buccal (facial) or front 102f side of the matrix 100) face, and are, for example, flush against each adjacent tooth 204 on the lingual (palatal) or inner side of each adjacent tooth 204. The matrix 100 may be held against the adjacent teeth 204 by adhesives and the like, manually with instruments by the clinician, or combinations of both.

With the matrix 100 firmly in place on the denticia (e.g., the lower denticia), composite material is placed into the matrix 100 by a syringe 210, through the aperture 108 (which faces and is accessed from the buccal side of the teeth), as shown, for example, in FIG. 6, with the material filling the interior 104 and cavities 106a (the material shown in diagonal lines). The syringe 210 operates under pressure, so that air bubbles are prevented during the filling process. The composite material has flowed into the interior 104 of the body 102 and through the openings 106x and into the cavities 106a in the respective arms 106, with the flowable and curable material (hardenable material) contacting the adjacent teeth 204 on their inner (lingual or palatal) surfaces. With the matrix 100 now filled, for example, such that there are no air bubbles and the like, curing light, such as ultraviolet (UV) light (wavelength, pulse lengths), from a light source 212 is applied to the matrix 100, for example, at both sides 102f, 102r, as shown in FIG. 6, for curing the material of the matrix 100.

The composite material, activated by the UV light, is allowed time to cure. Once cured, the matrix 100 is separated into sections 110a, 110b (by separating about the line 112), by the clinician, using instruments, including being cut into sections and removed. The two sections 110a, 110b, once removed from the mouth, expose the bridge 200, including the tooth 220 and the wings 222, which are now attached to the adjacent teeth 204, for example, the attachment caused by the curing of the material, and disposed on opposite sides of the bridge 200, as shown in FIG. 7.

The tooth 220 of the bridge 200 may now be shaped by the clinician using shaping, polishing, resurfacing, and/or grinding instruments, and the wings 222 (bridge portions), for joining the tooth 220 to the existing teeth 204, can also be worked, to be ground, shaped, resurfaced or the like. Reinforcing members, one or more, such as rods 130, strips, and the like, may also be placed in the bridge 200, so as to span the bridge portions (wings) 222, as shown in FIG. 8.

While the matrix 100 and methods for its use are shown and described herein for human teeth, the disclosed matrix and methods for its use are also suitable for animal teeth.

The disclosed subject matter is directed to a dental matrix. The dental matrix comprises: a first portion corresponding to the shape of a tooth, and for seating in a space in the oral denticia; a second portion, disposed on each lateral side of the first portion, and each of the second portions extending to a length over a respective tooth adjacent to the space; an interior cavity formed by the first and second portions, the interior cavity of each of the second portions including an open side for communication with the respective tooth adjacent to the space; and, at least one aperture on any of the first or second portions for receiving curable material.

Optionally, the dental matrix is such that the first and second portions are of a light translucent material.

Optionally, the dental matrix is such that the first and second portions are of an ultraviolet (UV) light translucent material.

Optionally, the dental matrix is such that the first second portions are integral.

Optionally, the dental matrix is such that open side is configured for facing the respective adjacent tooth.

Optionally, the dental matrix is such that the open side includes the buccal side.

Optionally, the dental matrix is such that the at least one aperture extends through the first portion into the interior cavity.

Optionally, the dental matrix is such that at least the first portion is separable into at least two sections.

Optionally, the dental matrix is such that the second portions are substantially rectangular in shape and coaxial with each other.

The disclosure is directed to a method for forming and placing a prosthetic tooth in the oral denticia. The method comprises: obtaining a dental matrix, the dental matrix comprising: a first portion corresponding to the shape of a tooth, and for seating in a space in the oral denticia; a second portion, disposed on each lateral side of the first portion, and each of the second portions extending to a length over a respective tooth adjacent to the space; an interior cavity formed by the first and second portions, the interior cavity of each of the second portions including an open side for communication with the respective tooth adjacent to the space; and, at least one aperture on any of the first or second portions for receiving curable material. The dental matrix is placed into the oral denticia such that the first portion seats in a space between adjacent teeth and the open sides of the second portion are in communication with the respective teeth, adjacent to the space. The next steps include filling the internal cavity of the matrix with a hardenable material, and, causing the hardenable material harden, such that the material which filled the cavity in the second portions has adhered to the respective adjacent tooth.

Optionally, the method is such that the filling the internal cavity includes injecting the hardenable material into the interior cavity through an aperture in first portion.

Optionally, the method is such that the hardenable material includes a light curable material.

Optionally, the method is such that the causing the hardenable material to harden includes applying light to the light curable material of the interior cavity.

Optionally, the method is such that the light curable material includes ultraviolet light curable material, and the applying the light includes applying ultraviolet light.

Optionally, the method is such that it additionally comprises: removing the matrix after the material has hardened.

Optionally, the method is such that it additionally comprises: providing reinforcing structure into the interior cavity between the interior cavities of the respective second portions prior to causing the hardenable material to harden.

Optionally, the method is such that the reinforcing structure includes one or more of: rods, fibers, and/or splints.

It will be appreciated that the above descriptions are intended only to serve as examples, and that many other embodiments are possible within the scope of the present invention as defined in the appended claims.

1. A dental matrix comprising:
a first portion corresponding to the shape of a tooth, and for seating in a space in the oral denticia;
a second portion, disposed on each lateral side of the first portion, and each of the second portions extending to a length over a respective tooth adjacent to the space;
an interior cavity formed by the first and second portions, the interior cavity of each of the second portions including an open side for communication with the respective tooth adjacent to the space; and,
at least one aperture on any of the first or second portions for receiving curable material.

2. The dental matrix of claim 1, wherein the first and second portions are of a light translucent material.

3. The dental matrix of claim 2, wherein the first and second portions are of an ultraviolet (UV) light translucent material.

4. The dental matrix of claim 1, wherein the first and second portions are integral.

5. The dental matrix of claim 1, wherein the open side is configured for facing the respective adjacent tooth.

6. The dental matrix of claim 5, wherein the open side includes the buccal side.

7. The dental matrix of claim 1, wherein the at least one aperture extends through the first portion into the interior cavity.

8. The dental matrix of claim 1, wherein at least the first portion is separable into at least two sections.

9. The dental matrix of claim 1, wherein the second portions are substantially rectangular in shape and coaxial with each other.

10. A method for forming and placing a prosthetic tooth in the oral denticia, the method comprising:
obtaining a dental matrix comprising:
a first portion corresponding to the shape of a tooth, and for seating in a space in the oral denticia;
a second portion, disposed on each lateral side of the first portion, and each of the second portions extending to a length over a respective tooth adjacent to the space;
an interior cavity formed by the first and second portions, the interior cavity of each of the second portions including an open side for communication with the respective tooth adjacent to the space; and,
at least one aperture on any of the first or second portions for receiving curable material.
placing the dental matrix into the oral denticia such that the first portion seats in a space between adjacent teeth and the open sides of the second portion are in communication with the respective teeth, adjacent to the space;
filling the internal cavity with a hardenable material; and
causing the hardenable material to harden, such that the material which filled the cavity in the second portions has adhered to the respective adjacent tooth.

11. The method of claim 10, wherein the filling the internal cavity includes injecting the hardenable material into the interior cavity through an aperture in first portion.

12. The method of claim 11, wherein the hardenable material includes a light curable material.

13. The method of claim 12, wherein causing the hardenable material to harden includes applying light to the light curable material of the interior cavity.

14. The method of claim 13, wherein the light curable material includes ultraviolet light curable material, and the applying the light includes applying ultraviolet light.

15. The method of claim 10, additionally comprising: removing the matrix after the material has hardened.

16. The method of claim 10, additionally comprising: providing reinforcing structure into the interior cavity between the interior cavities of the respective second portions prior to causing the hardenable material to harden.

17. The method of claim 16, wherein the reinforcing structure includes one or more of: rods, fibers, and/or splints.
